(19) United States
(12) Patent Application Publication
(10) Pub. No.: US 2008/0090932 A1
(43) Pub. Date: Apr. 17, 2008

(54) Radiation curable inkjettable adhesive

(75) Inventors: Sudhakar Madhusoodhanan, Cincinnati, OH (US); Stephen Sung, Liberty Township, OH (US)

Correspondence Address: HEXION SPECIALTY CHEMICALS, INC., 1600 SMITH STREET, P.O. BOX 4500, HOUSTON, TX, 77210-4500, US

(73) Assignee: Hexion Specialty Chemicals, Inc.

(21) Appl. No.: 11/546,212

(22) Filed: Oct. 11, 2006

(51) Int. Cl. C08J 3/28

(52) U.S. Cl. 522/144

(57) ABSTRACT

A radiation curable inkjettable adhesive composition combining the advantages of radical and cationic cure is described. The composition includes an acrylate ester monomer with hydroxyl functionality, preferably an acrylate ester of carboxylic acid, copolymerized with low viscosity aliphatic epoxies, utilizing both a photocation polymerization initiator and a free-radical photoinitiator. The adhesive composition is advantageously utilized in a piezoelectric drop-on-demand printhead, resulting in a polymeric film having dark cure and excellent adhesion to multiple substrates.

### FIELD OF THE INVENTION

The present invention relates to a hybrid ultra-violet “UV” curable inkjettable adhesive which can be advantageously utilized in piezoelectric drop-on-demand printheads. The composition includes: an acrylate ester monomer having hydroxyl functionality, specifically hydroxyl functional monoacrylates, or their mono(meth)acrylates, as well as acrylate esters of carboxylic acid esters; an aliphatic di-functional epoxy component; and a photoinitiator system which includes both a photocation polymerization initiator and a free-radical photoinitiator.

### BACKGROUND OF THE INVENTION

UV curable inkjettable liquids are generally prepared utilizing acrylates with a free-radical photoinitiator. However, such systems cure immediately, i.e. have no dark cure. Rapid cure leads to high shrinkage, low flexibility and poor adhesion to a variety of substrates, including metals and glass. The poor adhesion being largely due to the amount of shrinkage. On the other hand, inkjettable liquids prepared utilizing a photocation polymerization initiator, exhibit low shrinkage and provide good adhesion to metals and glass. However, with cycloaliphatic epoxy systems or acrylate systems, the higher viscosities do not make them ideal for certain inkjet applications.

### SUMMARY OF THE INVENTION

In one embodiment of the invention, there is provided a radiation curable inkjettable adhesive including an acrylate ester monomer having hydroxyl functionality, an aliphatic di-functional epoxy, a photocation polymerization initiator and a free-radical photoinitiator, wherein the acrylate ester monomer having hydroxyl functionality is selected a hydroxyl functional monoacrylate, a hydroxyl functional mono(meth)acrylate, an acrylate ester of a carboxylic acid ester or combinations thereof, and wherein the inkjettable adhesive has a cure time of greater than about 2 minutes, and less than about 70 minutes.

In another embodiment of the invention, there is provided a radiation curable inkjettable adhesive including an acrylate ester monomer having hydroxyl functionality, an aliphatic di-functional epoxy, a photocation polymerization initiator and a free-radical photoinitiator, wherein the acrylate ester monomer having hydroxyl functionality comprises an acrylate ester of a carboxylic acid ester.

In even another embodiment of the invention, there is provided a radiation curable inkjettable adhesive comprising an acrylate ester of a carboxylic acid ester, an aliphatic di-functional epoxy, a photocation polymerization initiator and a free-radical photoinitiator, wherein, based on the total weight of the inkjettable adhesive, the acrylate ester of a carboxylic acid ester is present in an amount of about 1 to about 25 wt. %, the aliphatic di-functional epoxy is present in an amount of about 30 to about 95 wt. %, the photocation polymerization initiator is present in an amount of about 0.5 to about 10 wt %, and the free-radical photoinitiator is present in an amount of about 0.5 to about 10 wt %.

### DETAILED DESCRIPTION OF THE INVENTION

The inkjettable adhesives of the invention are advantageously utilized in UV curable inkjet inks printed with piezoelectric drop-on-demand printheads. Inkjettable adhesive, as utilized herein, refers to a liquid that has adhesive/tacky properties, that can be jetted through a piezoelectric printhead and that it is tacky enough to glue two materials together. The tackiness is immediately present and remains for up to about 70 minutes before hardening. The tackiness provides a workable potlife for use in bonding different materials. Beyond 70 minutes, the liquid may no longer be tacky, but may still hold two materials together. Inkjettable, as utilized herein, refers to a liquid's ability to jet consistently and reliably through a piezoelectric printhead. To jet consistently and reliably, the viscosity range for the inkjettable adhesives of the invention is ideally about 5 to about 40 centipoises (cP) and the surface tension range is about 20 to about 40 dynes/cm.

In addition to being an inkjettable adhesive, the compositions of the invention may be accurately patterned, ideally within 1 micron, onto a substrate before the gluing process. The pattern can be used to create decorative or other functional effects not normally possible for traditional, higher viscosity adhesives.

It has now been discovered that an acrylate ester monomer with hydroxyl functionality, when copolymerized with low viscosity aliphatic epoxies, in the presence of a hybrid cure system including both a free radical and cationic cure (UV and thermal) curative, results in polymeric film having dark cure as well as excellent adhesion to multiple substrates including ceramic, glass, PET, PC and vinyl. The inkjettable adhesive composition of the invention includes an acrylate ester monomer having hydroxyl functionality, a di-functional aliphatic epoxy component, a photocation polymerization initiator and a free-radical photoinitiator.

### Acrylate Ester Monomer Having Hydroxyl Functionality

The inkjettable adhesive formulations of the present invention include an acrylate ester monomer having hydroxyl functionality. Suitable acrylate ester monomers include hydroxyl functional monoacrylates, or their mono(meth)acrylates, as well as acrylate esters of carboxylic acid esters and combinations thereof.

Hydroxyl-functional mono acrylates include but are not limited to hydroxyalkylacrylates and hydroxyalkyl(meth)acrylates wherein the hydroxyalkyl group contains 1 to 10 carbon atoms, preferably 1 to 6 carbon atoms. Suitable examples include hydroxyethylacrylate, hydroxyethyl(meth)acrylate, hydroxypropylacrylate, hydroxypropyl(meth)acrylate, hydroxybutylacrylate, hydroxybutyl(meth)acrylate, 2-hydroxy-3-phenyloxypropylacrylate 2-hydroxy-3-phenyloxypropyl(meth)acrylate, 1,4-butanediol monoacrylate, 1,4-butanediol mono(meth)acrylate, 4-hydroxycyclohexylacrylate, 4-hydroxycyclohexyl(meth)acrylate, 1,6-hexanediol monoacrylate, 1,6-hexanediol mono(meth)acrylate and any combination or subset thereof.

The amount of hydroxyl functional monoacrylates, or their mono(meth)acrylates utilized in the adhesive composition of the invention is about 1 to about 25 weight percent (wt. %), preferably about 5 to about 15 wt. %, and even more preferably about 3 to about 10 wt. % based on the total weight of the inkjet adhesive.

Acrylate esters of carboxylate acid esters include those compounds of the general formula:

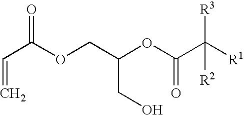

wherein, the carboxylate ester moiety is composed of alkyl or aryl or alkylaryl groups R¹, R² and R³, where the total number of carbon atoms included in groups R¹, R² and R³ range from 1 to 10. Each of R¹, R² and R³ group can independently be selected from phenyl, hydrogen, methyl, ethyl, propyl, butyl, pentyl, hexyl, heptyl, octyl and decyl. Representative examples of acids from which the carboxylate ester moiety can be derived include α,α-dimethyl-Caproic acid, α-ethyl-α-methyl-Caproic acid, α,α-diethyl-Caproic acid, α,α-diethyl-Valeric acid, α,α-dimethyl-Capric acid, α-butyl-α-ethyl-Capric acid, α,α-dimethyl-Enanthic acid, α,α-diethyl-Pelargonic acid, α-butyl-α-methyl-Caproic acid, α,α-dimethyl-Caprylic acid, α-methyl-α-propyl-Caproic acid, α-ethyl-α-methyl-Enanthic acid, α-methyl-α-propyl-Valeric acid, α-ethyl-α-methyl-Caprylic acid, α-butyl-α-methyl-Caprylic acid, α-ethyl-α-propyl-Caproic acid, α-ethyl-α-propyl-Valeric acid, α-butyl-α-ethyl-Pelargonic acid, α,α-Dimethyl Propionic acid (pivalic acid), neodecanoic acid and combinations as well as any subset thereof. Preferred examples of acrylate esters of carboxylic acid esters include but are not limited to acrylate esters of glycidyl esters of neodecanoic acid or acrylate ester of glycidyl ester of pivalic acid and combinations thereof.

The amount of acrylate esters of carboxylate acid esters utilized in the adhesive composition of the invention is about 1 to about 25 weight percent (wt. %), preferably about 5 to about 15 wt. %, and even more preferably about 3 to about 10 wt. % based on the total weight of the inkjet adhesive.

### Di-Functional Acrylate Component

The inkjettable adhesive formulations of the present invention may also optionally include an di-functional acrylate component. Suitable di-functional acrylate components are those that are liquids at a temperature of 25° C. Various acrylate resins may be used. Examples of these acrylate resins employable herein include tripropyleneglycol diacrylate, neopentyl-glycoldiacrylate, 1,6-hexanediol diacrylate. These resins may be used singly or in combination of two or more thereof.

When utilized, the amount of di-functional acrylate component in the adhesive composition of the invention is about 0 to about 95 wt. %, preferably about 1 to about 50 wt. %, and even more preferably about 5 to about 15 wt. % based on the total weight of the inkjet adhesive.

In one embodiment, inkjettable adhesive formulations of the present invention contains a mono-acrylate monomer, a di-functional acrylate monomer, or combinations thereof, and is free of tri-functional acrylate monomer.

### Aliphatic Di-Functional Epoxy Components

The inkjettable adhesive formulations of the present invention include an aliphatic di-functional epoxy component. Suitable di-functional epoxy components are preferably liquid epoxy resins, or combinations of epoxy resins, that are liquids at about 25° C. Suitable epoxy resins employable herein include diglycidylether of 1,6-hexanediol (HELOXY 66), 1,4-butanediol diglycidyl ether (HELOXY 67), polypropylenoxide diglycidyl ether (EPIKOTE 877) or diglycidyl ether of neopentyl glycol (HELOXY 68) and combinations thereof. All commercially available from Hexion Specialty Chemicals Inc., Columbus, Ohio. In a preferred embodiment the di-functional epoxy component is the glycidyl ether of neopentyl glycol.

The amount of di-functional epoxy components utilized in the adhesive composition of the invention is about 30 to about 95 wt. %, preferably about 40 to about 90 wt. %, and even more preferably about 50 to about 85 wt. % based on the total weight of the inkjet adhesive.

### Component Containing Both Vinyl Ether and Acrylate Functionality

The inkjettable adhesive formulations of the present invention may also optionally include a hybrid component containing both vinyl ether and acrylate functionality. These di-functional monomers are especially useful for decreasing the viscosity of curable compositions. Exemplary di-functional monomers include but are not limited to 2-(2-vinylethoxy)ethyl(meth)acrylate, 2-(2-vinyloxyethoxy)-2-propyl(meth)acrylate, 2-(2-vinyloxyethoxy)-3-propyl(meth)acrylate, 2-(2-vinyloxyethoxy)-2-butyl(meth)acrylate, 2-(2-vinyloxyethoxy)-4-butyl(meth)acrylate, 2-(2-allyloxyethoxy)ethyl(meth)acrylate, 2-(2-allyloxyethoxy)-2-propyl(meth)acrylate, 2-(2-allyloxyethoxy xy)-3-propyl(meth)acrylate, 2-(2-allyloxyethoxy)-2-butyl(meth)acrylate, 2-(2-allyloxyethoxy)-4-butyl(meth)acrylate, 2-(2-vinyloxypropoxy)ethyl(meth)acrylate, 2-(2-vinyloxypropoxy)2-propyl(meth)acrylate, 2-(2-vinyloxypropoxy)-3-propyl(meth)acrylate, 2-(3-vinyloxypropoxy)ethyl(meth)acrylate, 2-(3-vinyloxypropoxy)-2-propyl(meth)acrylate, 2-(3-vinyloxypropoxy)-3-propyl(meth)acrylate, and combinations comprising at least one of the foregoing. The compound 2-(2-vinyloxyethoxy)ethyl(meth)acrylate (VEEA and VEEM) is commercially available from Nippon Shokubai Co., Inc. Combinations comprising at least one of the foregoing can be used.

When utilized, the amount of di-functional monomer in the adhesive composition of the invention is about 0 to about 80 wt. % based on the total weight of the inkjet adhesive.

### Surfactant

The inkjettable adhesive formulations of the present invention may also optionally include a surfactant component based on polydimethylsiloxane, acrylic functional polydimethylsiloxane, polyacrylate copolymer. When utilized, the amount of surfactant in the adhesive composition of the invention is about 0 to about 5 wt. %, preferably about 0.001 to about 3 wt. %, and even more preferably about 0.01 to about 1 wt. % based on the total weight of the inkjet adhesive.

### Defoamer

The inkjettable adhesive formulations of the present invention may also optionally include a defoamer based on polysiloxanes. When utilized, the amount of defoamer in the adhesive composition of the invention is about 0 to about 5 wt. %, preferably about 0.001 to about 3 wt. %, and even more preferably about 0.01 to about 1 wt. % based on the total weight of the inkjet adhesive.

### Reactive Diluent

The inkjettable adhesive formulations of the present invention may also optionally include a reactive diluent such as alkylene carbonates or butyrolactone. These are useful in decreasing the viscosity of the curable compositions. Exemplary alkylene carbonates include but are not limited to glycerine carbonate, ethylene carbonate, propylene carbonate, butylene carbonate and combinations comprising at least one of the foregoing. When utilized, the amount of alkylene carbonate is about 0 to 25 wt. % based on the total weight of the inkjet adhesive.

### Photocation Polymerization Initiator

The inkjettable adhesive formulations of the present invention include a photocation polymerization initiator. The photocation polymerization initiator may contain an onium salt. Onium salt includes, for example, UVI-6950, UVI-6970, UVI-6974, UVI6976, UVI-6990 and UVI 6992 (available from the Dow Chemical Company), ADEKA Optomers SP-150, SP-151, SP-170, and SP-171 (available from Asahi Denka Kogyo), Ominicat 550, Omnicat 650, Omnicat BL550, Omnicat 440 (available from IGM resins), Irgacure 261 and 250 (available from Ciba), CI-2481, CI-2624, CI-2689, and CI-2064 (available from Nippon Soda), CD-1011, and CD-1012 (available from Sartomer), and DTS-102, DTS-103, NAT-103, NDS-103, TPS-103, MDS-103, MPI-103, BBI-103 (available from Midori Kagaku), Uvacure 1600 (available from Cytec Surface Specialties), combinations and sub-sets thereof.

### Free-Radical Photoinitiator

The inkjettable adhesive formulations of the present invention include a free-radical photoinitiator. The free-radical photoinitiator is selected based on the type of colorant present and the radiation wavelength used to cure the inkjettable adhesive. A blend of photoinitiators can be used, having peak energy absorption levels at varying wavelengths within the range of the selected radiation for cure. Preferably, the photoinitiator and photoiniator blends are sensitive to the wavelengths not absorbed, or only partially affected, by the pigments.

Examples of suitable photoinitiators include 2-benzyl-2-(dimethylamino)-4′-morpholinobutyrophenone; 2-hydroxy-2-methylpropiophenone; trimethylbenzophenone; methylbenzophenone; 1-hydroxycyclohexylphenyl ketone; isopropyl thioxanthone; 2,2-dimethyl-2-hydroxy-acetophenone; 2,2-dimethoxy-2-phenylacetophenone; 2-methyl-1-[4-(methylthio)phenyl]-2-morpholino-propan-1-one; 2,4,6-trimethylbenzyl-diphenyl-phosphine oxide; 1-chloro-4-propoxythioxanthone; benzophenone; bis(2,6-dimethoxybenzoyl)-2,4,4-trimethyl pentyl phosphine oxide; 5,7-diiodo-3-butoxy-6-fluorone, ethyl 2,4,6-trimethylbenzoylphenylhosphinate; oxy-phenyl-acetic acid 2-[2-oxo-2-phenyl-acetoxy-ethoxy]-ethyl ester and oxy-phenyl acetic acid 2-[2-hydroxy-ethoxy]-ethyl ester; 1-phenyl-2-hydroxy-2-methyl propanone; bis(2,4,6-trimethylbenzoyl)phenylphosphine oxide; camphorquinone; and the like. Combinations and sub-sets, comprising one or more the foregoing may also be used. Suitable commercially available photoinitiators include, but are not limited to Irgacure 907, Irgacure 819, Irgacure 2959, Irgacure 184, Irgacure 369, Benzophenone, SarCure SR1124 (ITX), Darocur D1173, Irgacure 651, TZT (SarCure SR1137), Methyl benzoylformate (Genocure MBF), H-Nu 470, H-Nu 535, H-Nu 635, H-Nu 640, H-Nu 660, Irgacure 754, Lucirin TPO-L.

Each of the photocation polymerization initiator and the free-radical photoinitiator are individually utilized in amounts effective to initiate polymerization in the presence of the curing radiation. The polymerization initiators may each separately be utilized in an about of about 0.5 to about 10 wt %, preferably about 1 to about 8 wt. %, more preferably about 2 to about 7 wt. %, and even more preferably about 3 to about 5 wt. %, based on the total weight of the inkjet adhesive.

The photoinitiator composition can further contain a photosensitizer, specifically 2-isopropyl-9H-thioxanthen-9-one, 2,4-diethylthioxanthone, 1-chloro-4-propoxy-9h-thioxanthene-9-one, 2-chlorothioxanthone and the like. Photoinitiators can be used, such as the commercially available Darocur ITX, CPTX, Genocure DETX, Speedcure CTX and the like. The coinitiator can be present in the inkjettable adhesive in an amount of about 0 to about 20 wt. %, specifically about 0.1 to about 10 wt. %, and more specifically about 0.2 to about 2 wt. %, based on the total weight of the inkjet adhesive.

### Pigment Compositions

The inkjettable adhesive of the invention may further contain a pigment composition comprising a pigment or combination of pigments to provide the desired color. Combinations of pigments and dye can be used, provided that the thermal stability of the resulting inkjettable adhesive is maintained.

Exemplary pigments include those having the following Color Index classifications: Green PG 7 and 36; Orange PO 5, 34, 36, 38, 43, 51, 60, 62, 64, 66, 67 and 73; Red PR 112, 149, 170, 178, 179, 185, 187, 188, 207, 208, 214, 220, 224, 242, 251, 254, 255, 260 and 264; Magenta/Violet PV 19, 23, 31, and 37, and PR 122, 181 and 202; Yellow PY 17, 120, 138, 139, 155, 151,168, 175, 179, 180, 181 and 185; Blue PB 15, 15:3, 15:4, 15:6; Black PB 2, 5 and 7; carbon black; titanium dioxide (including rutile and anatase); zinc sulfide, and the like.

Other specific pigments include, for example, IRGALITE BLUE GLVO, MONASTRAL BLUE FGX, IRGALITE BLUE GLSM, HELIOGEN BLUE L7101F, LUTETIA CYANINE ENJ, HELIOGEN BLUE L6700F, MONASTRAL GNXC, MONASTRAL GBX, MONASTRAL GLX, MONASTRAL 6Y, IRGAZIN DPP ORANGE RA, NOVAPERM ORANGE H5G70, NOVPERM ORANGE HL, MONOLITE ORANGE 2R, NOVAPERM RED HFG, HOSTAPERM ORANGE HGL, PALIOGEN ORANGE L2640, SICOFAST ORANGE 2953, IRGAZIN ORANGE 3GL, CHROMOPTHAL ORANGE GP, HOSTAPERM ORANGE GR, PV CARMINE HF4C, NOVAPERM RED F3RK 70, MONOLITE RED BR, IRGAZIN DPP RUBINE TR, IRGAZIN DPP SCARLET EK, RT-390-D SCARLET, RT-280-D RED, NOVAPERM RED HF4B, NOVAPERM RED HF3S, NOVAPERM RD HF2B, VYNAMON RED 3BFW, CHROMOPTHAL RED G, VYNAMON SCARLET 3Y, PALIOGEN RED L3585, NOVAPERM RED BL, PALIOGEN RED 3880 HD, HOSTAPERM P2GL, HOSTAPERM RED P3GL, HOSTAPERM RED E5B 02, SICOFAST RED L3550, SUNFAST MAGENTA 122, SUNFAST RED 122, SUNFAST VIOLET 19 228-0594, SUNFAST VIOLET 19 228-1220, CINQUASIA VIOLET RT-791-D, VIOLET R NRT-201-D, RED B NRT-796-D, VIOLET R RT-101-D, MONOLITE VIOLET 31, SUNFAST MAGENTA 22, MAGENTA RT-243-D, MAGENTA RT 355-D, RED B RT-195-D, CINQUASIA CARBERNET RT-385-D, MONOLITE VIOLET R, MICROSOL VIOLET R, CHROMOPTHAL VIOLET B, ORACET PINK RF, IRGALITE YELLOW 2GP, IRGALITE YELLOW WGP, PV FAST YELLOW HG, PV FAST YELLOW H3R, HOSTAPERM YELLOW H6G, PV FAST YELLOW, PALIOTOL YELLOW D1155 and IRGAZIN YELLOW 3R.

A number of different carbon black type pigments are commercially available, for example and carbon blacks such as SPECIAL BLACK 100, SPECIAL BLACK 250, SPECIAL BLACK 350, FW1, FW2 FW200, FW18, SPECIAL BLACK 4, NIPEX 150, NIPEX 160, NIPEX 180, SPECIAL BLACK 5, SPECIAL BLACK 6, PRINTEX 80, PRINTEX 90, PRINTEX 140, PRINTEX 150T, PRINTEX 200, PRINTEX U, and PRINTEX V, all available from Degussa, MOGUL L, REGAL 400R, REGAL 330, and MONARCH 900, available from Cabot Chemical Co., MA77, MA7, MA8, MA11, MA100, MA100R, MA100S, MA230, MA220, MA200RB, MA14, #2700B, #2650, #2600, #2450B, #2400B, #2350, #2300, #2200B, #1000, #970, #3030B, #3230B, all available from Mitsubishi, RAVEN 2500 ULTRA, Carbon black 5250, and Carbon Black 5750 from Columbia Chemical Co., and the like.

A number of titanium oxide pigments are also known. Nanostructured titania powders may be obtained, for example, from Nanophase Technologies Corporation, Burr Ridge, Ill., or under the trade names KRONOS® 1171 from Kronos Titan. As will be described in more detail below, titanium dioxide particles are prone to settling, and are therefore often surface treated. The titanium oxide particles can be coated with an oxide, such as alumina or silica, for example. One, two, or more layers of a metal oxide coating may be used, for example a coating of alumina and a coating of silica, in either order. This type of coated titanium oxide is commercially available from E. I. du Pont de Nemours and Company, Wilmington, Del., under the trade name R960 or R902. In the alternative, or in addition, the titanium oxide particles may be surface treated with an organic compatibilization agent such as a zirconate, titanate, silanes, silicones, and the like. Surface treatment of titanium dioxide coated with alumina includes, for example, a silicone surface treatment, preferably a dimethicone treatment using dimethicone oil or a stearic acid surface treatment. Stearic acid and alumina coated ultrafine titanium dioxide particles are commercially available, such as UV-Titan M160 from Presperse, Inc., South Plainfield, N.J. Suitable silanes include, for example, trialkoxysilanes, for example 3-(trimethoxysilyl)propyl methacrylate, which is available commercially from Dow Chemical Company, Wilmington, Del. under the trade name Z6030. The corresponding acrylate may also be used. Suitable titanium dioxides may include a decyltrimethoxysilane (DTMS) treated titanium dioxide (40 nanometer average particle diameter) from Tayca Corporation, TD3103 treated titanium dioxide available from Tayca Corporation, the titanium dioxides available from NANOTEK or Nanophase Technologies Corporation. Surface-treated titanium oxide hydroxide (TiO(OH)₂) with a 30 nanometer particle size is available as STT100H™ from Titan Kogyo).

The pigments are pre-dispersed prior to incorporation into the inkjettable adhesive, generally in one or more of the radiation curable materials used in the radiation curable composition. For example, the pigment can be dispersed in a multifunctional material such as tripropylene glycol diacrylate (TPGDA), a propoxylated neopentyl glycol diacrylate, a hyperbranched oligomers and aliphatic epoxy monomers such as diglycidylether of 1,6-hexanediol (HELOXY 66), 1,4-butanediol diglycidyl ether (HELOXY 67), polypropylenoxide diglycidyl ether (EPIKOTE 877) or diglycidyl ether of neopentyl glycol (HELOXY 68), 2-ethylhexyl glycidyl ether, (HELOXY 7) neodecanoic acid glycidyl ether, 2-(2-vinyloxyethoxy)ethyl(meth)acrylate (VEEA and VEEM) and the like. Other additives may be present to aid in dispersion of the pigments, for example AB-type block copolymers of an alkyl acrylate and a methyl methacrylate). Generally, the pigment comprises about 5 to about 50% of the dispersion.

In order to provide a better understanding of the present invention including representative advantages thereof, the following examples are offered. It is understood that the examples are for illustrative purposes and should not be regarded as limiting the scope of the invention to any specific materials or conditions.

### EXAMPLES

### Static Surface Tension:

The static surface tension is measured at thermal, chemical, and mechanical equilibrium between the inkjettable adhesive and the measurement instrument, and can correlate to how easily the inkjettable adhesive drop wets the substrate onto which it is jetted. Various methods can be used to determine static surface tension, for example the du Nouy method is known in the art. The inkjettable adhesives of the invention may have a static surface tension of about 20 to about 40 dynes per centimeter, preferably about 22 to about 38 dynes per centimeter, and more preferably about 24 to about 36 dynes per centimeter at 25° C.

### Time to Cure

Time taken to cure was determined by using the thumb test method, known in the art, to involve applying pressure with the thumb, then twisting to check if the surface is tacky, wet, or cured. The ink is cured if there is no smudge after the thumb test. Optionally, time to cure may be reduced by the application of heat as is known in the art. Depending upon the particular substrate, the inkjettable adhesives of the invention have a cure time of greater than about 2 minutes, preferably greater than about 5 minutes and less than about 70 minutes. In another embodiment, the inkjettable adhesives of the invention have a cure time of between about 8 minutes and about 70 minutes, preferably between about 30 and 60 minutes.

### Procedure for Adhesion Testing

Crosshatch adhesion was determined according to the following procedure. A film of an inkjettable adhesive is prepared at a thickness of 9 micrometers using a #6 Mayer rod, cured using a mercury vapor lamp at a dose of 700 mJ/cm², H lamp, and conditioned for 16-24 hours at 25° C. (±2° C.), and at a relative humidity of 50% (±5%). A series of 6 parallel incisions of 2 to 2.5 cm in length and spaced 2.0 mm apart is made in the film using a suitable cutting tool such as a Gardco PA-2000 cutting tool with 6 parallel blades, followed by a second set of incisions of the same dimensions and rotated 90° to the first set. In this way a crosshatch pattern is made, and the crosshatched surface is cleaned using a brush or compressed air to remove particulate contaminants. A length of 7 to 8 cm of a suitable tape, such as 3M 610 tape by 3M Corporation, is applied to the crosshatched area and rubbed smoothed out to remove any trapped air bubbles, and to ensure a good contact. The tape is then pulled off within 90 seconds (±30 seconds) upon application to the crosshatched area. The crosshatch areas are then quantified according to the method of ASTM D3359 (Test Method B) where “49” refers to the best adhesion and “0” refers to the worst adhesion.

### Procedure for Viscosity

The viscosity of the inkjettable adhesive was determined using a Haake Roto Visco 1 and a TCP/P -Peltier Temperature Control Unit. The viscosity was obtained at a temperature of 25° C. and the results are provided in centipoises (cP). The inkjettable adhesive of the invention may have a viscosity of about 5 to about 40 cP, preferably about 10 to about 30 cP, and more preferably about 12 to about 25 cP at 25° C.

### Procedure for MEK Rubs

The MEK (methyl ethyl ketone) rub technique is a method for assessing the solvent resistance of a cured inkjettable adhesive by incorporating ASTM D4752 into ASTM D3732-82. The inkjettable adhesive to be cured is applied to the substrate using #6 Mayer rod. The coated film was cured at a dose of 700 mJ/cm² using a Fusion H lamp, max power is 600 watts/inch, (dosage recorded by PowerMap). Test areas on the ink film surface of at least 2 inches long are selected for testing. The ball end of a hammer wrapped in two thicknesses of cheesecloth is saturated to a dripping wet condition with the MEK. The wet ball end is rubbed across the 2-inch portion of the cured film, one forward and one backward movement constitutes a single rub. The surface is rubbed until the ink has been completely removed from any point along the test area

### Degree of Cure

The degree of cure of the adhesive was determined by measuring percent reacted epoxy, vinyl ether and acrylate peak of the cured adhesive at ca. 909, 1620 and 1407 cm⁻¹ respectively using a Nicolet 860 Magna FT-IR bench equipped with a Dura sample IR II ATR (Diamond). A drop of liquid adhesive is placed onto the diamond ATR crystal and a spectrum of the unreacted liquid is obtained. A cured film of adhesive is prepared for spectral analysis by forming a film having a thickness of about 7-10 micrometers using #6 Mayer rod drawdowns substrate. The adhesive film is then cured using a Fusion H lamp, max power is 600 watts/inch, at a dose of 700 mJ/cm². The cured adhesive film is removed from the substrate and the top surface and the bottom surface of the film (the face adjacent to the substrate) is measured for degree of cure, with 100% equaling fully cured and 0% equaling absence of cure.

The degree of cure at the top surface of the film is determined by cutting a piece of film (about ½″×½″) and having the top surface of the film face the diamond ATR crystal while a spectrum is obtained.

The degree of cure at the face of the film opposite to the surface is obtained by facing the bottom surface of the film to the diamond ATR crystal while a spectrum is obtained.

The peak for the acrylate double bond is observed in the liquid adhesive at about 1407 cm⁻¹. The area of the peak is measured starting from about 1424 cm⁻¹ to 1393 cm⁻¹. Peak area at 1407 cm⁻¹ for the cured ink top as well as bottom surface is also measured similar to the procedure for the liquid adhesive.

The degree of cure is calculated using the following formulas: % cure for Top Surface=[1−( Area 1407 cm⁻¹ top/Area 1407 cm⁻¹ liquid)]×100, and % cure for Bottom Surface =[1−( Area 1407 cm⁻¹ bottom/Area 1407 cm⁻¹ liquid)]×100.

A similar procedure is also used for measuring degree of cure for the epoxy functional group by measuring the peak area at about 909 cm⁻¹.

Preferred compositions of the inkjettable adhesive are provided in Table 1, wherein Compositions 1, 2 and 3 are illustrative of the invention and comparative compositions CE1 through CE6 are composition prepared in accordance with those disclosed in EP 540 203 B2 and counterpart U.S. Pat. No. 5,257,646.

TABLE 1

| Raw Material | Composition 1 | CE 1 | CE2 | CE3 | Composition 2 | Composition 3 | CE4 | CE5 | CE6 |
|---|---|---|---|---|---|---|---|---|---|
| Byk 361N | | 0.05 | | | 0.025 | | 0.025 | | |
| Byk 080A | | | | | 0.025 | | 0.025 | | |
| MEHQ | 0.03 | 0.03 | 0.03 | 0.03 | 0.025 | 0.03 | 0.025 | 0.03 | 0.03 |
| ITX | 1.20 | 1.2 | 1.20 | 1.20 | 0.705 | 1.20 | 0.704 | 1.20 | 1.20 |
| UVACURE 1600 | 4.00 | 4 | 4.00 | 4.00 | 3 | 4.00 | 3 | 4.00 | 4.00 |
| Uvacure 1500 | | | | | | | 18 | | |
| Genocure MBF | 5.00 | 5 | 5.00 | 5.00 | 4 | 5.00 | 4 | 5.00 | 5.00 |
| 4-HBA | | | | 25.00 | | | | | 25.00 |
| Heloxy 67 | 61.28 | | 77.28 | 52.30 | | 73.78 | | 89.78 | 64.80 |
| Heloxy 68 | | 52.22 | | | 76.22 | | 58.22 | | |
| ACE | 16.00 | 25 | | | 16 | 16.00 | 16 | | |
| Cyan | 12.50 | 12.5 | 12.50 | 12.50 | | | | | |
| Dispersion | | | | | | | | | |
| Total | 100.00 | 100.00 | 100.00 | 100.03 | 100.00 | 100.00 | 100.00 | 100.00 | 100.03 |
| Time to cure (mins) | 30 mins | wet | soft and | 0.00 | 8 | 60.00 | 0 | 0.00 | 0.00 |
| | | | uncured | | | | | | |

In Table 1, BYK 361N and BYK 080A are surfactants commercially available from BYK-Chemie, Wallingford, Conn. MEHQ is 4-methoxyphenol. ITX is a photosensitizer, isopropylthioxanthone available commercially from Sartomer Company, Inc. as ESACURE ITX. UVACURE 1500 is a cycloaliphatic diepoxy commercially available from Cytec Surface Specialties. Cationic photoinitiator UVACURE 1600 is based on iodonium salts and also commercially available from Cytec Surface Specialties. GENOCURE MBF is a glyoxolate based free radical initiators used for crosslinking commercially available from Rahn Corporation. 4-HBA is hydroxyl butylacrylate available from Osaka Organic Chemical. HELOXY 67 and HELOXY 68 are di-functional epoxy monomers and ACE is an acrylate ester of glycidyl ester of neodecanoic acid with a hydroxyl group on one the side chains of the molecule. HELOXY 67 HELOXY 68 and ACE are available from Hexion Specialty Chemicals Inc., Columbus, Ohio. The Cyan dispersion is 20% cyan pigment in TPGDA. Ink drawdowns using a #6 Mayer rod on the substrate were cured with Hanovia mercury vapor (H) lamp at 700 mJ/cm² energy density.

The time to cure was compared between the disclosed inkjettable compositions of the invention some examples in the literature. The cure time is significantly higher for the disclosed inkjettable adhesive compositions compared to the prior art examples thereby providing significant tack time for a workable adhesive.

Properties of the adhesives and cured film are provided in Table 2.

TABLE 2

| Property | Composition 1 | Composition 2 | CE 5 |
|---|---|---|---|
| Viscosity/25 C. (cps) | 18.04 | 19.7 | |
| Cure conditions | Hanovia, | Hanovia, | Hanovia, |
| | H lamp | H lamp | H lamp |
| | 700 mJ/cm2 | 700 mJ/cm2 | 700 mJ/cm2 |
| Cure time on glass (min) | 90 | 60 | 0 |

Cross hatch adhesion

| | | | |
|---|---|---|---|
| a. Glass | 49 | 49 | 49 |
| b. PET | 47 | 49 | 49 |
| c. PC | 0 | 0 | 0 |

MEK rub

| | | | |
|---|---|---|---|
| a. Glass | 1 | 4 | 4 |
| b. PET | 2 | 5 | 5 |
| c. PC | 1 | 4 | 4 |

Degree of cure (%) using FTIr on PC

| | | | |
|---|---|---|---|
| Top surface acrylate | 99.56 | 91.94 | 99.99 |
| cure at 1407 cm-1 (%) | | | |
| Top surface epoxy cure | 99.98 | 99.87 | 99.98 |
| at 909 cm-1 (%) | | | |
| Bottom surface acrylate | >99.99 | 93.1 | 99.96 |
| cure at 1407 cm-1 (%) | | | |
| Bottom surface epoxy | >99.99 | 99.99 | 99.96 |
| cure at 909 cm-1 (%) | | | |
| Surface tension | 35.5 | 35.5 | 35.1 |
| (dynes/cm) | | | |

The viscosity is in the jettable range. The cure time is significantly high for the clear adhesive. The dark cure of the epoxy functionality was studied by FTIr and the final degree of cure is very high. The tackiness prevents from measuring initial degree of cure. The dark cure is very useful in providing high tack for bonding.

The jet operating window of the clear ink was tested on a Spectra SM-128 peizo (DOD) printhead. The firing frequency was at 16 kHz using a (waveform) rise/fall time of 4 microseconds and fire pulse width of 8 microseconds. The jet operating window is defined by the voltage and temperature conditions where all 128 jets fire constantly for 3 minutes without any of them dropping out. The jet operating window for this clear ink was from 80-130 V at 30° C., 80-120 V at 40° C., and 80-100 V at 50° C.

Advantages of the hybrid UV cure compositions of the present invention combine the positive features of a free radical and cationic curing. The significant dark cure leads to a tacky adhesive which helps to bond substrates; and provides low shrinkage and adhesion to multiple substrates such as ceramics, PET, glass. Low oxygen inhibition unlike free radical chemistry. The low viscosity monomers permit use of hybrid UV curable inkjettable adhesives in piezo drop-on-demand printheads.

We claim:

1. A radiation curable inkjettable adhesive comprising an acrylate ester monomer having hydroxyl functionality, an aliphatic di-functional epoxy, a photocation polymerization initiator and a free-radical photoinitiator,
wherein the acrylate ester monomer having hydroxyl functionality is selected from the group consisting of a hydroxyl functional monoacrylate, a hydroxyl functional mono(meth)acrylate, an acrylate ester of a carboxylic acid ester and combinations thereof, and
wherein the inkjettable adhesive has a cure time of greater than about 2 minutes, and less than about 70 minutes.

2. The inkjettable adhesive of claim 1 wherein the acrylate ester monomer having hydroxyl functionality is a hydroxyalkylacrylate or a hydroxyalkyl(meth)acrylate, each having a hydroxyalkyl group containing from 1 to 10 carbon atoms, and utilized in an amount of about 1 to about 25 wt. %, based on the total weight of the inkjettable adhesive.

3. The inkjettable adhesive of claim 2 wherein the acrylate ester monomer having hydroxyl functionality is selected from the group consisting of hydroxyethylacrylate, hydroxyethyl(meth)acrylate, hydroxypropylacrylate, hydroxypropyl(meth)acrylate, hydroxybutylacrylate, hydroxybutyl(meth)acrylate, 2-hydroxy-3-phenyloxypropylacrylate 2-hydroxy-3-phenyloxypropyl(meth)acrylate, 1,4-butanediol monoacrylate, 1,4-butanediol mono(meth)acrylate, 4-hydroxycyclohexylacrylate, 4-hydroxycyclohexyl(meth)acrylate, 1,6-hexanediol monoacrylate, 1,6-hexanediol mono(meth)acrylate and combinations thereof.

4. The inkjettable adhesive of claim 3 wherein the acrylate ester monomer having hydroxyl functionality is selected from the group consisting of 2-hydroxyethyl acrylate or 2-hydroxyethyl methacrylate, hydroxybutylacrylate and combinations thereof.

5. A radiation curable inkjettable adhesive comprising an acrylate ester monomer having hydroxyl functionality, an aliphatic di-functional epoxy, a photocation polymerization initiator and a free-radical photoinitiator,
wherein the acrylate ester monomer having hydroxyl functionality comprises an acrylate ester of a carboxylic acid ester.

6. The inkjettable adhesive of claim 5 wherein the acrylate ester monomer having hydroxyl functionality is an acrylate ester of carboxylate acid ester of the general formula: 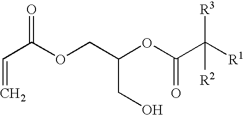
having a carboxylate ester moiety is composed of alkyl, aryl or alkylaryl groups R¹, R² and R³ containing a total number of from 1 to 10 carbon atoms.

7. The inkjettable adhesive of claim 6 wherein the carboxylate ester moiety is derived from α,α-dimethyl-Caproic acid, α-ethyl-α-methyl-Caproic acid, α,α-diethyl-Caproic acid, α,α-diethyl-Valeric acid, α,α-dimethyl-Capric acid, α-butyl-α-ethyl-Capric acid, α,α-dimethyl-Enanthic acid, α,α-diethyl-Pelargonic acid, α-butyl-α-methyl-Caproic acid, α,α-dimethyl-Caprylic acid, α-methyl-α-propyl-Caproic acid, α-ethyl-α-methyl-Enanthic acid, α-methyl-α-propyl-Valeric acid, α-ethyl-α-methyl-Caprylic acid, α-butyl-α-methyl-Caprylic acid, α-ethyl-α-propyl-Caproic acid, α-ethyl-α-propyl-Valeric acid, α-butyl-α-ethyl-Pelargonic acid, α,α-Dimethyl Propionic acid (pivalic acid), neodecanoic acid and combinations thereof.

8. The inkjettable adhesive of claim 5 wherein the 1 wherein the acrylate ester monomer having hydroxyl functionality is an acrylate ester of carboxylic acid ester selected from the group consisting of acrylate esters of glycidyl esters of neodecanoic acid, acrylate ester of glycidyl ester of pivalic acid and combinations thereof.

9. The inkjettable adhesive of claim 5 wherein the acrylate ester monomer having hydroxyl functionality is an acrylate ester of glycidyl ester of neodecanoic acid.

10. The inkjettable adhesive of claim 1 wherein the aliphatic di-functional epoxy component is a liquid at about 25° C.

11. The inkjettable adhesive of claim 1 wherein the aliphatic di-functional epoxy component is selected from the group consisting of diglycidylether of 1,6-hexanediol, 1,4-butanediol diglycidyl ether, polypropylenoxide diglycidyl ether, diglycidyl ether of neopentyl glycol and combinations thereof. All commercially available from Hexion Specialty Chemicals Inc., Columbus Ohio.

12. The inkjettable adhesive of claim 10 wherein the di-functional epoxy component is the glycidyl ether of neopentyl glycol.

13. The inkjettable adhesive of claim 1 wherein the di-functional epoxy is present in an amount of about 30 to about 95 wt. %, and the acrylate ester monomer having hydroxyl functionality is present in an amount of about 1 to about 25 wt. %.

14. The inkjettable adhesive of claim 1 having a viscosity between about 5 to about 40 centipoises at 25° C.

15. The inkjettable adhesive of claim 1 having a surface tension between about 20 to about 40 dynes/cm at 25° C.

16. The inkjettable adhesive of claim 1 wherein, based on the total weight of the inkjettable adhesive, the acrylate ester monomer having hydroxyl functionality is present in an amount of about 1 to about 25 wt. %, the aliphatic di-functional epoxy is present in an amount of about 30 to about 95 wt. %, the photocation polymerization initiator is present in an amount of about 0.5 to about 10 wt %, and the free-radical photoinitiator is present in an amount of about 0.5 to about 10 wt %.

17. The inkjettable adhesive of claim 1 further comprising a pigment.

18. The inkjettable adhesive of claim 1 wherein the adhesive, when used in a drop-on-demand or impulse inkjet printhead at a frequency of about 16 kHz, has an operating window of reliable printing at a voltage of about 80 to 100 volts and a temperature of about 30° C. to about 50° C. where all jets fire constantly and where no jet nozzles fail in the printhead after three minutes of continuous jetting.

19. The inkjettable adhesive of claim 1 wherein the adhesive, upon curing on a polyethylene terephthalate or glass substrate using a dose of about 700 mJ/cm² using a mercury vapor lamp, has an adhesion rating of greater than about 15 out of a maximum of 49 as determined according to ASTM method D 3359 (Test Method B).

20. A radiation curable inkjettable adhesive comprising an acrylate ester of a carboxylic acid ester, an aliphatic di-functional epoxy, a photocation polymerization initiator and a free-radical photoinitiator, wherein, based on the total weight of the inkjettable adhesive, the acrylate ester of a carboxylic acid ester is present in an amount of about 1 to about 25 wt. %, the aliphatic di-functional epoxy is present in an amount of about 30 to about 95 wt. %, the photocation polymerization initiator is present in an amount of about 0.5 to about 10 wt %, and the free-radical photoinitiator is present in an amount of about 0.5 to about 10 wt %.
